(19) United States
(12) Patent Application Publication
(10) Pub. No.: US 2023/0294314 A1
(43) Pub. Date: Sep. 21, 2023

(54) SWITCH-ACTUATED MULTI-TOOL APPARATUS

(71) Applicant: Marshall Gause, Thornton, CO (US)

(72) Inventor: Marshall Gause, Thornton, CO (US)

(21) Appl. No.: 17/845,011

(22) Filed: Jun. 21, 2022

Related U.S. Application Data
(60) Provisional application No. 63/322,457, filed on Mar. 22, 2022.
(60) Provisional application No. 63/320,497, filed on Mar. 16, 2022.

(51) Int. Cl. B26B 11/00; B26B 1/10

(52) U.S. Cl. CPC B26B 11/00; B26B 1/10; B26B 11/008; B25G 1/085

(57) ABSTRACT

The present disclosure provides a switch-actuated multi-tool apparatus. The switch-actuated multi tool apparatus includes one or more cutting tools. In addition, the switch-actuated multi tool apparatus includes a housing module. The housing module encloses the one or more cutting tools in a non-functioning state and the housing module has a grip for holding the switch-actuated multi-tool apparatus when the one or more cutting tools is in a functioning state. Further, the switch-actuated multi tool apparatus includes a switch positioned within or around the housing module. The switch actuates the one or more cutting tools. Furthermore, the switch-actuated multi tool apparatus includes a detachable attachment module positioned anywhere around periphery of the housing module. The detachable attachment module allows one or more accessories to be detachably connected to the switch-actuated multi-tool apparatus.

### TECHNICAL FIELD

The present invention relates to the field of multi-purpose apparatuses, in particular, relates to a switch-actuated multi-tool apparatus.

### BACKGROUND

The present invention relates generally to multi-tools, which typically are knife-based tools. Where a knife is a tool that has a cutting edge or blade attached to a handle or hilt. The majority of modern knives have fixed or folding blades, and blade patterns and styles vary. In addition, the knives can be used for a variety of tasks. There are kitchen knives for preparing foods (the chef's knife, the paring knife, the bread knife, the cleaver), table knives (butter knives and steak knives), switchblades, and knives for throwing or juggling.

These days, users often seek to attach accessories to the knife-based tools, which enables the which makes the knife-based tools a multi-tools apparatus. For example, the users may want to attach carabiner hook to the knife-based tools for common uses such as climbing, fall arrest systems, arboriculture, caving, sailing, hot air ballooning, rope rescue, construction, industrial rope work, window cleaning, whitewater rescue, and acrobatics. In another example, it difficult to attach or carry screwdrivers, screw heads, and bottle opener along with the knife-based tools. In yet another example, it is difficult to attach or carry wireless Bluetooth earbuds, wireless chargers, power bank, and tracking devices along with the knife-based tools. Also, current knife-based tools do not have the provision to open the door without touching the surface of door handle.

In light of the foregoing discussion, there exists a need for a novel switch-actuated multi-tool apparatus which overcomes the above-cited drawbacks.

### SUMMARY

Aspects and advantages of embodiments of the present disclosure will be set forth in part in the following description, or can be learned from the description, or can be learned through practice of the embodiments.

One example aspect of the present disclosure is directed to a switch-actuated multi-tool apparatus. The switch-actuated multi tool apparatus includes one or more cutting tools. In addition, the switch-actuated multi tool apparatus includes a housing module. The housing module encloses the one or more cutting tools in a non-functioning state and the housing module has a grip for holding the switch-actuated multi-tool apparatus when the one or more cutting tools is in a functioning state. Further, the switch-actuated multi tool apparatus includes a switch positioned within or around the housing module. The switch actuates the one or more cutting tools. Furthermore, the switch-actuated multi tool apparatus includes a detachable attachment module positioned anywhere around periphery of the housing module. The detachable attachment module allows one or more accessories to be detachably connected to the switch-actuated multi-tool apparatus.

In an embodiment of the present disclosure, the one or more accessories may include a carabiner hook, a case, and a magnet. The magnet detachably attached to the switch-actuated multi-tool apparatus may allow the switch-actuated multi-tool apparatus to be attached to any metallic surface.

In an embodiment of the present disclosure, the detachable attachment module may be one of a suction-based detachable attachment module, a male/female slot-based detachable attachment module, a clip-based detachable attachment module, a magnet-based detachable attachment module, a channel locking detachable attachment module, and a T-slot locking detachable attachment module.

In an embodiment of the present disclosure, the one or more accessories may be a wallet, a cover, a headgear, a belt, a glove compartment, a dashboard, a glove, a garment, a bag, a container, an umbrella, a footwear, a handbag, a mechanical tool, a dispenser, a fastener, a drive socket, a cork screw, an opening tool, an illumination tool, a writing tool, a shearing tool, a keyring, a plier, a key fob, a medicines holder, a kickstand, an earbuds case, a door opener, a charger, a power bank, and a tracking module.

In an embodiment of the present disclosure, the switch-actuated multi-tool apparatus may be detachably connected to the drive socket using the detachable attachment module. In addition, the drive socket may accommodate at least one bit of different sizes.

In an embodiment of the present disclosure, the switch-actuated multi-tool apparatus may be detachably connected to the cork screw using the detachable attachment module for opening a bottle.

In an embodiment of the present disclosure, the switch-actuated multi-tool apparatus may be detachably connected to the wrench and a socket using the detachable attachment module.

In an embodiment of the present disclosure, the switch-actuated multi-tool apparatus may be detachably connected to the door opener using the detachable attachment module for no-touch opening of a door.

In an embodiment of the present disclosure, the switch-actuated multi-tool apparatus may be detachably connected to a holder using the detachable attachment module for storing at least one bit of different sizes.

In an embodiment of the present disclosure, the switch-actuated multi-tool apparatus may be detachably connected to the wallet using the detachable attachment module.

In an embodiment of the present disclosure, the switch-actuated multi-tool apparatus may be detachably connected to the earbuds case using the detachable attachment module.

In an embodiment of the present disclosure, the switch-actuated multi-tool apparatus may be detachably connected to the glove compartment or the dashboard using the detachable attachment module.

In an embodiment of the present disclosure, the switch-actuated multi-tool apparatus may be detachably connected to a vehicle handle using the detachable attachment module.

In an embodiment of the present disclosure, the switch-actuated multi-tool apparatus may be detachably connected to the tracking module using the detachable attachment module.

In an embodiment of the present disclosure, the switch-actuated multi-tool apparatus may be detachably connected to the garment or the headgear or the belt or the glove or the footwear using the detachable attachment module.

In an embodiment of the present disclosure, the switch-actuated multi-tool apparatus may be detachably connected to the illumination tool using the detachable attachment module.

In an embodiment of the present disclosure, the switch-actuated multi-tool apparatus may be detachably connected to the umbrella using the detachable attachment module.

In an embodiment of the present disclosure, the switch-actuated multi-tool apparatus may further include one or more sensors operably coupled with the switch-actuated multi-tool apparatus. In addition, the one or more sensors may enable automatic functioning of the switch-actuated multi-tool apparatus and may automate attachment and detachment of the one or more accessories.

In an embodiment of the present disclosure, the switch-actuated multi-tool apparatus may further include a processor and a memory coupled with the one or more sensors. In addition, the memory may include instructions configured to cause the processor to automate functioning of the switch-actuated multi-tool apparatus and automatically attach and detach the one or more accessories. Further, the one or more sensors and the processor may be located inside or around the switch-actuated multi-tool apparatus.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Having thus described the invention in general terms, reference will now be made to the accompanying drawings, which are not necessarily drawn to scale, and wherein:

FIG. 1 illustrates a perspective view of a first exemplary switch-actuated multi-tool apparatus, in accordance with various embodiments of the present disclosure;

FIG. 2 illustrates a perspective view of a second exemplary switch-actuated multi-tool apparatus, in accordance with various embodiments of the present disclosure;

FIG. 3 illustrates a perspective view of a third exemplary switch-actuated multi-tool apparatus, in accordance with various embodiments of the present disclosure;

FIG. 4 illustrates a perspective view of a fourth exemplary switch-actuated multi-tool apparatus, in accordance with various embodiments of the present disclosure; and

FIG. 5 illustrates a perspective view of a fifth exemplary switch-actuated multi-tool apparatus, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

A switch-actuated multi-tool apparatus is a type of hand tool that combines multiple functions into a single unit. The switch-actuated multi-tool apparatus may be used by any user. The user may include but not limited to an individual, a mechanic, a carpenter, a mountaineer, a backpacker, a trekker, a hiker, a technician, a repairman, and a serviceman.

The switch-actuated multi-tool apparatus has a principal component which is one or more cutting tools. Generally, the one or more cutting tools are hardened tools that are used to cut, shape, and remove material from a workpiece through shear deformation. In addition, the one or more cutting tools are generally made from a variety of hardened metal alloys that are ground to a specific shape. However, the one or more cutting tools may be made of any suitable material. In an embodiment of the present disclose, the one or more cutting tools is an automatic cutting tool. The automatic cutting tool is a type of sliding cutting tool or a pivot cutting tool included in a housing module, the automatic cutting tool is automatically extended by a spring when the user operates a switch on the housing module. In another embodiment of the present disclosure, the one or more cutting tools is a semi-automatic cutting tool. In yet another embodiment of the present disclosure, the one or more cutting tools is a manual cutting tool. In yet another embodiment of the present disclosure, the one or more cutting tools is a foldable cutting tool.

In an implementation of the present disclosure, the one or more cutting tools may be a drop-point blade cutting tool. In another implementation of the present disclosure, the one or more cutting tools may be a sheepsfoot blade cutting tool. In yet another implementation of the present disclosure, the one or more cutting tools may be a wharncliffe blade cutting tool. In yet another implementation of the present disclosure, the one or more cutting tools may be a clip-point blade cutting tool. In yet another implementation of the present disclosure, the one or more cutting tools may be a normal blade/straight back blade cutting tool. In yet another implementation of the present disclosure, the one or more cutting tools may be a tanto blade cutting tool. In yet another implementation of the present disclosure, the one or more cutting tools may be a gut hook cutting tool. In yet another implementation of the present disclosure, the one or more cutting tools may be a hawkbill blade cutting tool. In yet another implementation of the present disclosure, the one or more cutting tools may be a needle-point blade cutting tool. In yet another implementation of the present disclosure, the one or more cutting tools may be a spear-point blade cutting tool. In yet another implementation of the present disclosure, the one or more cutting tools may be a spey-point blade cutting tool. In yet another implementation of the present disclosure, the one or more cutting tools may be a trailing-point blade cutting tool.

The switch-actuated multi-tool apparatus includes the housing module. In addition, the housing module encloses the one or more cutting tools in a non-functioning state. The non-functioning state is a specific condition of the switch-actuated multi-tool apparatus when the one or more cutting tools are not operating. Further, the housing module has a grip to hold the switch-actuated multi-tool apparatus when the one or more cutting tools is in a functioning state. The functioning state is a specific condition of the switch-actuated multi-tool apparatus when the one or more cutting tools are operating.

The housing module is made of a material selected from a group of materials including thermoplastic polyurethane, polycarbonate, acrylonitrile butadiene styrene, polyvinyl chloride, polypropylene, plastic, rubber, metallic materials, alloys, composites, nylon, silicon, and wood. In some implementations, the housing module is made of any other suitable material.

The switch-actuated multi-tool apparatus includes the switch. In addition, the switch is positioned within or around the housing module. The switch actuates the one or more cutting tools. Further, the switch when actuated automatically extends the one or more cutting tools through a spring. However, it will be apparent to those skilled in the art that different mechanism can be used for automatically extending the one or more cutting tools. In an embodiment of the present invention, the switch may enable out the front slide opening of the one or more cutting tools from the housing module. In another embodiment of the present invention, the switch may enable double action out the front slide opening of the one or more cutting tools from the housing module. In yet another embodiment of the present invention, the switch may enable side-opening of the one or more cutting tools from the housing module. In yet another embodiment of the present invention, the switch may enable single action out the front slide opening of the one or more cutting tools from the housing module.

The switch-actuated multi-tool apparatus includes a detachable attachment module. In addition, the detachable attachment module is positioned anywhere around periphery of the housing module. Further, the detachable attachment module allows one or more accessories to be detachably connected to the switch-actuated multi-tool apparatus. Furthermore, the detachable attachment module may be detachably positioned anywhere around the housing module using any of one or more chemical adhesives, one or more mechanical means and one or more tapes. In an example, the detachable attachment module is affixed or attached to the housing module of the switch-actuated multi-tool apparatus using the one or more mechanical means (Let's say nuts and bolts). In another example, the detachable attachment module is affixed or attached to the housing module of the switch-actuated multi-tool apparatus using the one or more mechanical means (Let's say screws). In yet another example, the detachable attachment module is affixed or attached to the housing module of the switch-actuated multi-tool apparatus using the one or more mechanical means (Let's say pins and rivets). In yet another example, the detachable attachment module is affixed or attached to the housing module of the switch-actuated multi-tool apparatus using the one or more chemical adhesives (Let's say Epoxy adhesives).

The detachable attachment module has a first detachable attachment element and a second detachable attachment element. In addition, the first detachable attachment element and the second detachable attachment element may be attached to the housing module of the switch-actuated multi-tool apparatus and the one or more accessories respectively, or vice-versa. Further, one end of the first detachable attachment element may be attached to the housing module of the switch-actuated multi-tool apparatus by any of the one or more chemical adhesives, the one or more mechanical means and the one or more tapes and other end of the first detachable attachment element is detachably coupled with the second detachable attachment element. Similarly, one end of the second detachable attachment element may be attached to the one or more accessories by any of the one or more chemical adhesives, the one or more mechanical means and the one or more tapes and other end of the second detachable attachment element is detachably coupled with the first detachable attachment element. In some implementations, the first detachable attachment element and the second detachable attachment element are in-built within the housing module and the one or more accessories respectively, or vice-versa.

The detachable attachment module may be one of a suction-based detachable attachment module, a male/female slot-based detachable attachment module, a clip-based detachable attachment module, a magnet-based detachable attachment module, a channel locking detachable attachment module, and a T-slot locking detachable attachment module.

The one or more accessories may include but not limited to a carabiner hook, a case, and a magnet. In an embodiment of the present disclosure, the magnet detachably attached to the switch-actuated multi-tool apparatus allows the switch-actuated multi-tool apparatus to be attached to any metallic surface.

The one or more accessories may further include but not limited to a wallet, a cover, a headgear, a belt, a glove compartment, a dashboard, a glove, a garment, a bag, a container, an umbrella, a footwear, a handbag, a mechanical tool, a dispenser, a fastener, a drive socket, a cork screw, an opening tool, an illumination tool, a writing tool, a shearing tool, a keyring, a plier, a key fob, a medicines holder, a kickstand, an earbuds case, a door opener, a charger, a power bank, and a tracking module.

In one implementation of the present disclosure, the switch-actuated multi-tool apparatus may be detachably connected to a drive socket using the detachable attachment module. In addition, the drive socket may accommodate at least one bit of different sizes. For example, the at least one bit may be a Phillips bit, a Flat/Slotted bit, a Hex Key bit, a Torx bit, and a Robertson bit. In an embodiment of the present disclosure, the first detachable attachment element may be detachably attached to the housing module of the switch-actuated multi-tool apparatus and the second detachable attachment element may be detachably attached to the drive socket for detachably connecting the housing module and the drive socket. In another embodiment of the present disclosure, the second detachable attachment element may be detachably attached to the housing module of the switch-actuated multi-tool apparatus and the first detachable attachment element may be detachably attached to the drive socket for detachably connecting the housing module and the drive socket. In yet another embodiment of the present disclosure, the first detachable attachment element and the second detachable attachment element are in-built within the housing module of the switch-actuated multi-tool apparatus and the drive socket respectively, or vice-versa for detachably connecting the housing module and the drive socket.

Further, the switch-actuated multi-tool apparatus may be detachably connected to a holder using the detachable attachment module for storing the at least one bit of different sizes. The holder is made of a material selected from a group of materials including thermoplastic polyurethane, polycarbonate, acrylonitrile butadiene styrene, polyvinyl chloride, polypropylene, plastic, rubber, metallic materials, alloys, composites, nylon, silicon, and wood. In some implementations, the holder is made of any other suitable material.

In some implementations of the present disclosure, the switch-actuated multi-tool apparatus may further include one or more sensors operably coupled with the switch-actuated multi-tool apparatus. In addition, the one or more sensors may enable automatic functioning of the switch-actuated multi-tool apparatus and may automate attachment and detachment of the one or more accessories. Further, the one or more sensors include but may not be limited to one or more image sensors, one or more thermal sensors, one or more proximity sensors, one or more temperature sensors, and one or more microphones. However, the one or more sensors may be any other suitable sensor.

In some implementations of the present disclosure, the switch-actuated multi-tool apparatus may further include a processor and a memory coupled with the one or more sensors. In addition, the memory includes instructions configured to cause the processor to automate functioning of the switch-actuated multi-tool apparatus and automatically attach and detach the one or more accessories. Further, the one or more sensors and the processor are located inside or around the housing module of the switch-actuated multi-tool apparatus.

In another implementation of the present disclosure, the switch-actuated multi-tool apparatus may be detachably connected to a cork screw using the detachable attachment module for opening a bottle. In an example, the bottle may be a wine bottle. In an embodiment of the present disclosure, the first detachable attachment element may be detachably attached to the housing module of the switch-actuated multi-tool apparatus and the second detachable attachment element may be detachably attached to the cork screw for detachably connecting the housing module and the cork screw. In another embodiment of the present disclosure, the second detachable attachment element may be detachably attached to the housing module of the switch-actuated multi-tool apparatus and the first detachable attachment element may be detachably attached to the cork screw for detachably connecting the housing module and the cork screw. In yet another embodiment of the present disclosure, the first detachable attachment element and the second detachable attachment element are in-built within the housing module of the switch-actuated multi-tool apparatus and the cork screw respectively, or vice-versa for detachably connecting the housing module and the cork screw.

In yet another implementation of the present disclosure, the switch-actuated multi-tool apparatus may be detachably connected to a wrench and a socket using the detachable attachment module. In an example, the wrench and the socket are an oxygen tank wrench and a spoke wrench respectively. In an embodiment of the present disclosure, the first detachable attachment element may be detachably attached to the housing module of the switch-actuated multi-tool apparatus and the second detachable attachment element may be detachably attached to the wrench and the socket for detachably connecting the housing module and the wrench and the socket. In another embodiment of the present disclosure, the second detachable attachment element may be detachably attached to the housing module of the switch-actuated multi-tool apparatus and the first detachable attachment element may be detachably attached to the wrench and the socket for detachably connecting the housing module and the wrench and the socket. In yet another embodiment of the present disclosure, the first detachable attachment element and the second detachable attachment element are in-built within the housing module of the switch-actuated multi-tool apparatus and the wrench & the socket respectively, or vice-versa for detachably connecting the housing module and the wrench & the socket.

In yet another implementation of the present disclosure, the switch-actuated multi-tool apparatus may be detachably connected to the door opener using the detachable attachment module for no-touch opening of a door. In an embodiment of the present disclosure, the first detachable attachment element may be detachably attached to the housing module of the switch-actuated multi-tool apparatus and the second detachable attachment element may be detachably attached to the door opener for detachably connecting the housing module and the door opener. In another embodiment of the present disclosure, the second detachable attachment element may be detachably attached to the housing module of the switch-actuated multi-tool apparatus and the first detachable attachment element may be detachably attached to the door opener for detachably connecting the housing module and the door opener. In yet another embodiment of the present disclosure, the first detachable attachment element and the second detachable attachment element are in-built within the housing module of the switch-actuated multi-tool apparatus and the door opener respectively, or vice-versa for detachably connecting the housing module and the door opener.

In yet another implementation of the present disclosure, the switch-actuated multi-tool apparatus may be detachably connected to the wallet using the detachable attachment module. In an embodiment of the present disclosure, the first detachable attachment element may be detachably attached to the housing module of the switch-actuated multi-tool apparatus and the second detachable attachment element may be detachably attached to the wallet for detachably connecting the housing module and the wallet. In another embodiment of the present disclosure, the second detachable attachment element may be detachably attached to the housing module of the switch-actuated multi-tool apparatus and the first detachable attachment element may be detachably attached to the wallet for detachably connecting the housing module and the wallet. In yet another embodiment of the present disclosure, the first detachable attachment element and the second detachable attachment element are in-built within the housing module of the switch-actuated multi-tool apparatus and the wallet respectively, or vice-versa for detachably connecting the housing module and the wallet.

In yet another implementation of the present disclosure, the switch-actuated multi-tool apparatus may be detachably connected to the earbuds case using the detachable attachment module. In an embodiment of the present disclosure, the first detachable attachment element may be detachably attached to the housing module of the switch-actuated multi-tool apparatus and the second detachable attachment element may be detachably attached to the earbuds case for detachably connecting the housing module and the earbuds case. In another embodiment of the present disclosure, the second detachable attachment element may be detachably attached to the housing module of the switch-actuated multi-tool apparatus and the first detachable attachment element may be detachably attached to the earbuds case for detachably connecting the housing module and the earbuds case. In yet another embodiment of the present disclosure, the first detachable attachment element and the second detachable attachment element are in-built within the housing module of the switch-actuated multi-tool apparatus and the earbuds case respectively, or vice-versa for detachably connecting the housing module and the earbuds case.

In yet another implementation of the present disclosure, the switch-actuated multi-tool apparatus may be detachably connected to the glove compartment or the dashboard of any vehicle using the detachable attachment module. In an embodiment of the present disclosure, the first detachable attachment element may be detachably attached to the housing module of the switch-actuated multi-tool apparatus and the second detachable attachment element may be detachably attached to the glove compartment or the dashboard of any vehicle for detachably connecting the housing module and the glove compartment or the dashboard of any vehicle. In another embodiment of the present disclosure, the second detachable attachment element may be detachably attached to the housing module of the switch-actuated multi-tool apparatus and the first detachable attachment element may be detachably attached to the glove compartment or the dashboard of any vehicle for detachably connecting the housing module and the glove compartment or the dashboard of any vehicle. In yet another embodiment of the present disclosure, the first detachable attachment element and the second detachable attachment element are in-built within the housing module of the switch-actuated multi-tool apparatus and the glove compartment or the dashboard of any vehicle respectively, or vice-versa for detachably connecting the housing module and the glove compartment or the dashboard of any vehicle.

In yet another implementation of the present disclosure, the switch-actuated multi-tool apparatus may be detachably connected to a vehicle handle using the detachable attachment module. In an example, the vehicle handle is a handle of a motorcycle. In another example, the vehicle handle is a handle of a bike. In an embodiment of the present disclosure, the first detachable attachment element may be detachably attached to the housing module of the switch-actuated multi-tool apparatus and the second detachable attachment element may be detachably attached to the vehicle handle for detachably connecting the housing module and the vehicle handle. In another embodiment of the present disclosure, the second detachable attachment element may be detachably attached to the housing module of the switch-actuated multi-tool apparatus and the first detachable attachment element may be detachably attached to the vehicle handle for detachably connecting the housing module and the vehicle handle. In yet another embodiment of the present disclosure, the first detachable attachment element and the second detachable attachment element are in-built within the housing module of the switch-actuated multi-tool apparatus and the vehicle handle respectively, or vice-versa for detachably connecting the housing module and the vehicle handle.

In yet another implementation of the present disclosure, the switch-actuated multi-tool apparatus may be detachably connected to the tracking module using the detachable attachment module. For example, using an AirTag as the tracking module. In an embodiment of the present disclosure, the first detachable attachment element may be detachably attached to the housing module of the switch-actuated multi-tool apparatus and the second detachable attachment element may be detachably attached to the tracking module for detachably connecting the housing module and the tracking module. In another embodiment of the present disclosure, the second detachable attachment element may be detachably attached to the housing module of the switch-actuated multi-tool apparatus and the first detachable attachment element may be detachably attached to the tracking module for detachably connecting the housing module and the tracking module. In yet another embodiment of the present disclosure, the first detachable attachment element and the second detachable attachment element are in-built within the housing module of the switch-actuated multi-tool apparatus and the tracking module respectively, or vice-versa for detachably connecting the housing module and the tracking module.

In yet another implementation of the present disclosure, the switch-actuated multi-tool apparatus may be detachably connected to the garment or the headgear or the belt or the glove or the footwear using the detachable attachment module. For example, using a brim of a hat or a helmet as the headgear. Similarly, using a vest or a jacket as the garment. In an embodiment of the present disclosure, the first detachable attachment element may be detachably attached to the housing module of the switch-actuated multi-tool apparatus and the second detachable attachment element may be detachably attached to the garment or the headgear or the belt or the glove or the footwear for detachably connecting the housing module and the garment or the headgear or the belt or the glove or the footwear. In another embodiment of the present disclosure, the second detachable attachment element may be detachably attached to the housing module of the switch-actuated multi-tool apparatus and the first detachable attachment element may be detachably attached to the garment or the headgear or the belt or the glove or the footwear for detachably connecting the housing module and the garment or the headgear or the belt or the glove or the footwear. In yet another embodiment of the present disclosure, the first detachable attachment element and the second detachable attachment element are in-built within the housing module of the switch-actuated multi-tool apparatus and the garment or the headgear or the belt or the glove or the footwear respectively, or vice-versa for detachably connecting the housing module and the garment or the headgear or the belt or the glove or the footwear.

In yet another implementation of the present disclosure, the switch-actuated multi-tool apparatus may be detachably connected to the illumination tool using the detachable attachment module. For example, using a battery-operated torch or a wireless flashlight as the illumination tool. In an embodiment of the present disclosure, the first detachable attachment element may be detachably attached to the housing module of the switch-actuated multi-tool apparatus and the second detachable attachment element may be detachably attached to the illumination tool for detachably connecting the housing module and the illumination tool. In another embodiment of the present disclosure, the second detachable attachment element may be detachably attached to the housing module of the switch-actuated multi-tool apparatus and the first detachable attachment element may be detachably attached to the illumination tool for detachably connecting the housing module and the illumination tool. In yet another embodiment of the present disclosure, the first detachable attachment element and the second detachable attachment element are in-built within the housing module of the switch-actuated multi-tool apparatus and the illumination tool respectively, or vice-versa for detachably connecting the housing module and the illumination tool.

In yet another implementation of the present disclosure, the switch-actuated multi-tool apparatus may be detachably connected to the umbrella using the detachable attachment module. In an embodiment of the present disclosure, the first detachable attachment element may be detachably attached to the housing module of the switch-actuated multi-tool apparatus and the second detachable attachment element may be detachably attached to the umbrella for detachably connecting the housing module and the umbrella. In another embodiment of the present disclosure, the second detachable attachment element may be detachably attached to the housing module of the switch-actuated multi-tool apparatus and the first detachable attachment element may be detachably attached to the umbrella for detachably connecting the housing module and the umbrella. In yet another embodiment of the present disclosure, the first detachable attachment element and the second detachable attachment element are in-built within the housing module of the switch-actuated multi-tool apparatus and the umbrella respectively, or vice-versa for detachably connecting the housing module and the umbrella.

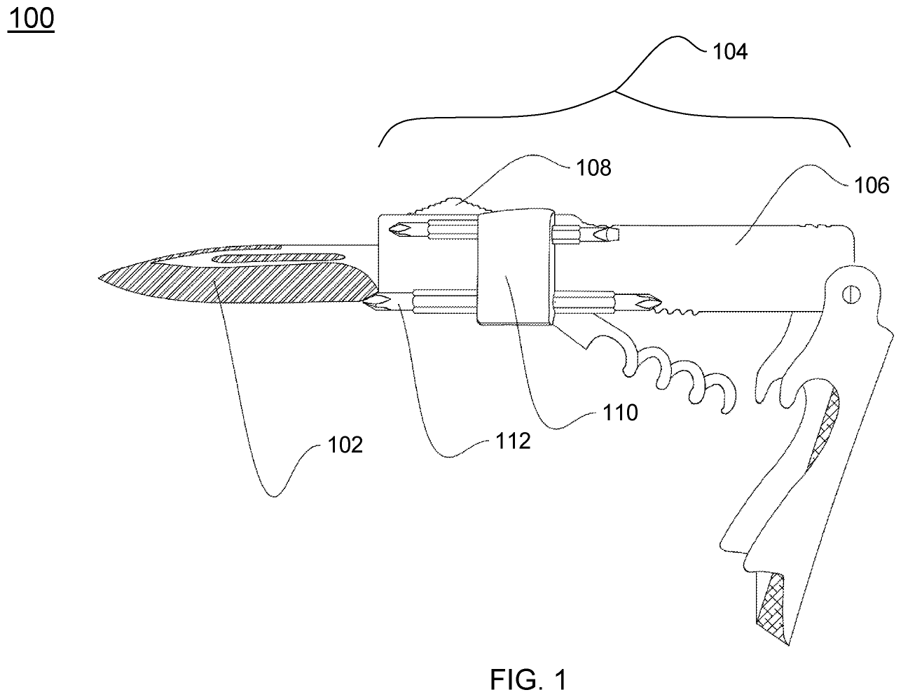

Now referring to FIG. 1, a perspective view of a first exemplary switch-actuated multi-tool apparatus 100 is illustrated, in accordance with various embodiments of the present disclosure. The first exemplary switch-actuated multi-tool apparatus 100 includes a cutting tool 102, a housing module 104 having a grip 106, and a switch 108. In addition, the first exemplary switch-actuated multi-tool apparatus 100 includes a detachable attachment module (not shown in FIG. 1). Further, the first exemplary switch-actuated multi-tool apparatus 100 includes a holder 110 detachably connected to the housing module 104 of the first exemplary switch-actuated multi-tool apparatus 100 through the detachable attachment module. For example, the detachable attachment module is a male/female slot-based detachable attachment module. A first detachable attachment element of the detachable attachment module is a male slot-based detachable attachment element. A second detachable attachment element of the detachable attachment module is a female slot-based detachable attachment element.

The male slot-based detachable attachment element and the female slot-based detachable attachment element are detachable attached to the housing module 104 of the first exemplary switch-actuated multi-tool apparatus 100 and the holder 110. In addition to that, the male slot-based detachable attachment element engages with the female slot-based detachable attachment element for detachably connecting the housing module 104 of the first exemplary switch-actuated multi-tool apparatus 100 and the holder 110.

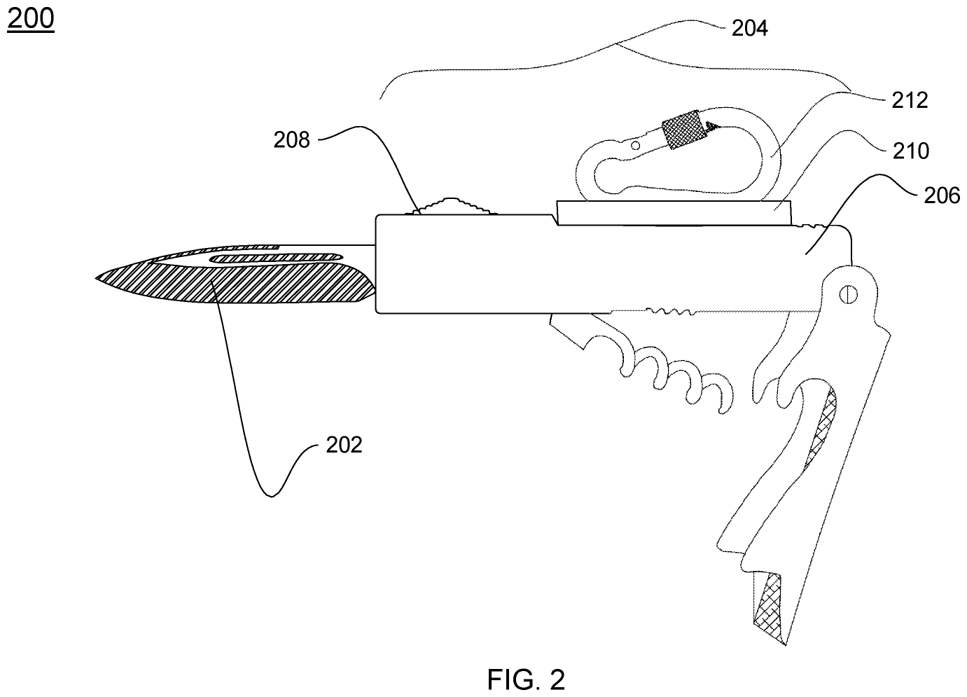

Now referring to FIG. 2, a perspective view of a second exemplary switch-actuated multi-tool apparatus 200 is illustrated, in accordance with various embodiments of the present disclosure. The second exemplary switch-actuated multi-tool apparatus 200 includes a cutting tool 202, a housing module 204 having a grip 206, and a switch 208. In addition, the second exemplary switch-actuated multi-tool apparatus 200 includes a detachable attachment module 210. Further, the second exemplary switch-actuated multi-tool apparatus 200 includes a carabiner hook 212 detachably connected to the housing module 204 of the second exemplary switch-actuated multi-tool apparatus 200 through the detachable attachment module 210. For example, the detachable attachment module 210 is a channel locking detachable attachment module. A first detachable attachment element of the detachable attachment module 210 is a first channel based detachable attachment element. A second detachable attachment element of the detachable attachment module 210 is a second channel based detachable attachment element.

The first channel based detachable attachment element and the second channel based detachable attachment element are detachable attached to the housing module 204 of the second exemplary switch-actuated multi-tool apparatus 200 and the carabiner hook 212. In addition to that, the first channel based detachable attachment element slides into the second channel based detachable attachment element for detachably connecting the housing module 204 of the second exemplary switch-actuated multi-tool apparatus 200 and the carabiner hook 212.

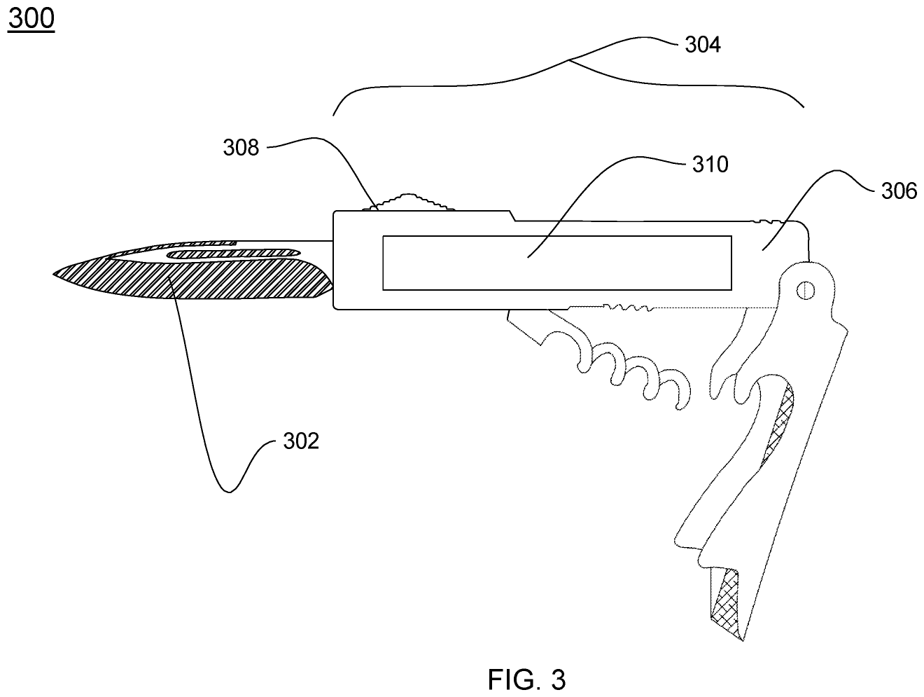

Now referring to FIG. 3, a perspective view of a third exemplary switch-actuated multi-tool apparatus 300 is illustrated, in accordance with various embodiments of the present disclosure. The third exemplary switch-actuated multi-tool apparatus 300 includes a cutting tool 302, a housing module 304 having a grip 306, and a switch 308. In addition, the third exemplary switch-actuated multi-tool apparatus 300 includes a detachable attachment module 310. Further, the detachable attachment module 310 is detachably attached to the housing module 304 of the third exemplary switch-actuated multi-tool apparatus 300 using the one or more chemical adhesives. For example, the detachable attachment module 310 is a magnet-based detachable attachment module. The magnet-based detachable attachment module enables to the third exemplary switch-actuated multi-tool apparatus 300 detachably connected to any metallic body or components.

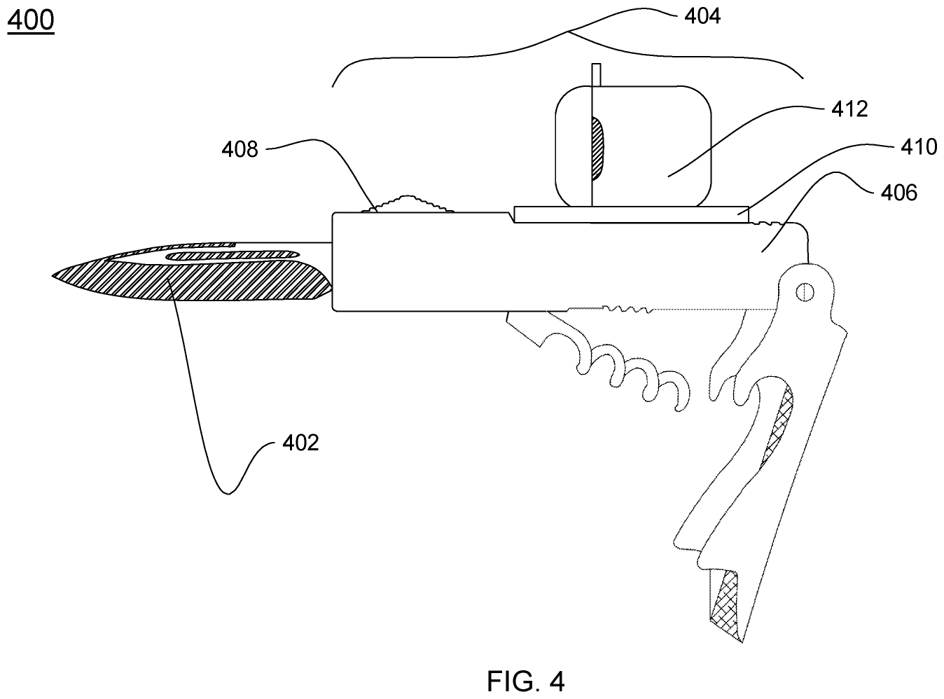

Now referring to FIG. 4, a perspective view of a fourth exemplary switch-actuated multi-tool apparatus 400 is illustrated, in accordance with various embodiments of the present disclosure. The fourth exemplary switch-actuated multi-tool apparatus 400 includes a cutting tool 402, a housing module 404 having a grip 406, and a switch 408. In addition, the fourth exemplary switch-actuated multi-tool apparatus 400 includes a detachable attachment module 410. Further, the fourth exemplary switch-actuated multi-tool apparatus 400 includes an earbuds case 412 detachably connected to the housing module 404 of the fourth exemplary switch-actuated multi-tool apparatus 400 through the detachable attachment module 410. For example, the detachable attachment module 410 is a T-slot locking detachable attachment module. A first detachable attachment element of the detachable attachment module 410 is a grooved channel. A second detachable attachment element of the detachable attachment module 410 is a T-slot slider.

The grooved channel and the T-slot slider are detachable attached to the housing module 404 of the fourth exemplary switch-actuated multi-tool apparatus 400 and the earbuds case 412. In addition to that, the T-slot slider slides into the grooved channel for detachably connecting the housing module 404 of the fourth exemplary switch-actuated multi-tool apparatus 400 and the earbuds case 412.

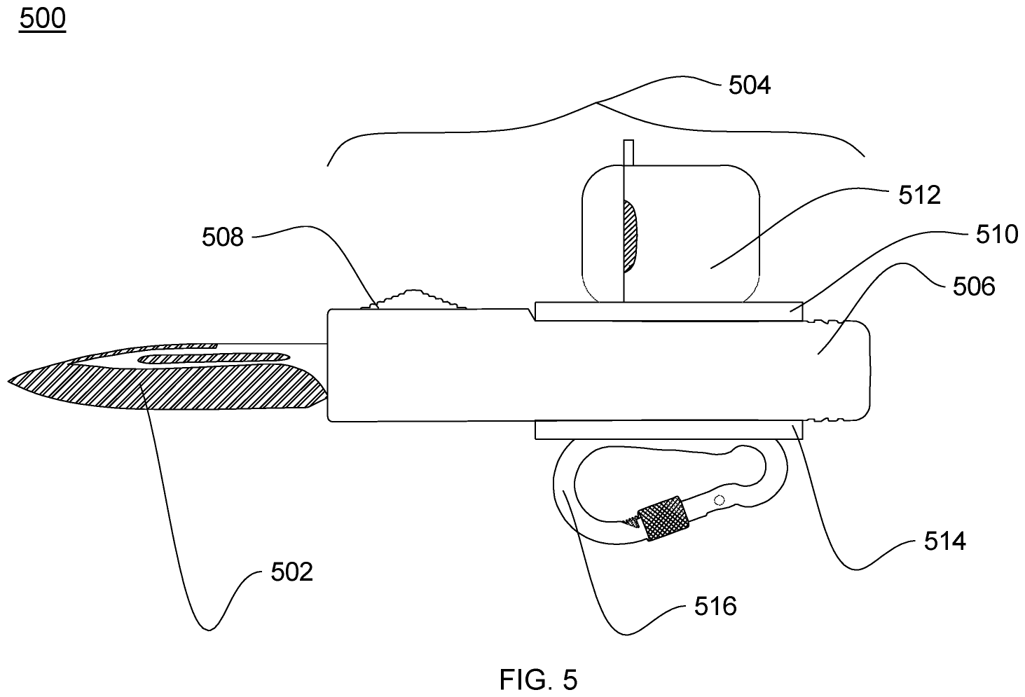

Now referring to FIG. 5, a perspective view of a fifth exemplary switch-actuated multi-tool apparatus 500 is illustrated, in accordance with various embodiments of the present disclosure. The fifth exemplary switch-actuated multi-tool apparatus 500 includes a cutting tool 502, a housing module 504 having a grip 506, and a switch 508. In addition, the fifth exemplary switch-actuated multi-tool apparatus 500 includes a first detachable attachment module 510. Further, the fifth exemplary switch-actuated multi-tool apparatus 500 includes an earbuds case 512 detachably connected to the housing module 504 of the fifth exemplary switch-actuated multi-tool apparatus 500 through the first detachable attachment module 510. Furthermore, the fifth exemplary switch-actuated multi-tool apparatus 500 includes a second detachable attachment module 514. Moreover, the fifth exemplary switch-actuated multi-tool apparatus 500 includes a carabiner hook 516 detachably connected to the housing module 504 of the fifth exemplary switch-actuated multi-tool apparatus 500 through the second detachable attachment module 514. For example, the first detachable attachment module 510 and the second detachable attachment module 514 are a suction-based detachable attachment module and a male/female slot-based detachable attachment module respectively.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

I claim:

1. A switch-actuated multi-tool apparatus, comprising:
one or more cutting tools;
a housing module, wherein the housing module encloses the one or more cutting tools in a non-functioning state and the housing module has a grip for holding the switch-actuated multi-tool apparatus when the one or more cutting tools is in a functioning state;
a switch, wherein the switch is positioned within or around the housing module, wherein the switch actuates the one or more cutting tools; and
a detachable attachment module, wherein the detachable attachment module is positioned anywhere around periphery of the housing module, wherein the detachable attachment module allows one or more accessories to be detachably connected to the switch-actuated multi-tool apparatus.

2. The switch-actuated multi-tool apparatus as recited in claim 1, wherein the one or more accessories comprising a carabiner hook, a case, and a magnet, wherein the magnet detachably attached to the switch-actuated multi-tool apparatus allows the switch-actuated multi-tool apparatus to be attached to any metallic surface.

3. The switch-actuated multi-tool apparatus as recited in claim 1, wherein the detachable attachment module is one of a suction-based detachable attachment module, a male/female slot-based detachable attachment module, a clip-based detachable attachment module, a magnet-based detachable attachment module, a channel locking detachable attachment module, and a T-slot locking detachable attachment module.

4. The switch-actuated multi-tool apparatus as recited in claim 1, wherein the one or more accessories may be a wallet, a cover, a headgear, a belt, a glove compartment, a dashboard, a glove, a garment, a bag, a container, an umbrella, a footwear, a handbag, a mechanical tool, a dispenser, a fastener, a drive socket, a cork screw, an opening tool, an illumination tool, a writing tool, a shearing tool, a keyring, a plier, a key fob, a medicines holder, a kickstand, an earbuds case, a door opener, a charger, a power bank, and a tracking module.

5. The switch-actuated multi-tool apparatus as recited in claim 1, wherein the switch-actuated multi-tool apparatus may be detachably connected to a drive socket using the detachable attachment module, wherein the drive socket may accommodate at least one bit of different sizes.

6. The switch-actuated multi-tool apparatus as recited in claim 1, wherein the switch-actuated multi-tool apparatus may be detachably connected to a cork screw using the detachable attachment module for opening a bottle.

7. The switch-actuated multi-tool apparatus as recited in claim 1, wherein the switch-actuated multi-tool apparatus may be detachably connected to a wrench and a socket using the detachable attachment module.

8. The switch-actuated multi-tool apparatus as recited in claim 1, wherein the switch-actuated multi-tool apparatus may be detachably connected to a door opener using the detachable attachment module for no-touch opening of a door.

9. The switch-actuated multi-tool apparatus as recited in claim 1, wherein the switch-actuated multi-tool apparatus may be detachably connected to a holder using the detachable attachment module for storing at least one bit of different sizes.

10. The switch-actuated multi-tool apparatus as recited in claim 1, wherein the switch-actuated multi-tool apparatus may be detachably connected to a wallet using the detachable attachment module.

11. The switch-actuated multi-tool apparatus as recited in claim 1, wherein the switch-actuated multi-tool apparatus may be detachably connected to an earbuds case using the detachable attachment module.

12. The switch-actuated multi-tool apparatus as recited in claim 1, wherein the switch-actuated multi-tool apparatus may be detachably connected to a glove compartment or a dashboard using the detachable attachment module.

13. The switch-actuated multi-tool apparatus as recited in claim 1, wherein the switch-actuated multi-tool apparatus may be detachably connected to a vehicle handle using the detachable attachment module.

14. The switch-actuated multi-tool apparatus as recited in claim 1, wherein the switch-actuated multi-tool apparatus may be detachably connected to a tracking module using the detachable attachment module.

15. The switch-actuated multi-tool apparatus as recited in claim 1, wherein the switch-actuated multi-tool apparatus may be detachably connected to a garment or a headgear or a belt or a glove or a footwear using the detachable attachment module.

16. The switch-actuated multi-tool apparatus as recited in claim 1, wherein the switch-actuated multi-tool apparatus may be detachably connected to an illumination tool using the detachable attachment module.

17. The switch-actuated multi-tool apparatus as recited in claim 1, wherein the switch-actuated multi-tool apparatus may be detachably connected to an umbrella using the detachable attachment module.

18. The switch-actuated multi-tool apparatus as recited in claim 1, may further comprise one or more sensors operably coupled with the switch-actuated multi-tool apparatus, wherein the one or more sensors may enable automatic functioning of the switch-actuated multi-tool apparatus and may automate attachment and detachment of the one or more accessories.

19. The switch-actuated multi-tool apparatus as recited in claim 1, may further comprise a processor and a memory coupled with one or more sensors, wherein the memory comprises instructions configured to cause the processor to automate functioning of the switch-actuated multi-tool apparatus and automatically attach and detach the one or more accessories, wherein the one or more sensors and the processor are located inside or around the switch-actuated multi-tool apparatus.
